(19) United States
(12) Patent Application Publication
(10) Pub. No.: US 2023/0356432 A1
(43) Pub. Date: Nov. 9, 2023

(54) Method and Device for Increasing the Force Required to Separate a Solidified Deformable Material into at Least Two Portions

(71) Applicant: Gregory Walter, Shorewood, IL (US)

(72) Inventor: Gregory Walter, Shorewood, IL (US)

(21) Appl. No.: 18/144,184

(22) Filed: May 6, 2023

Related U.S. Application Data
(60) Provisional application No. 63/339,789, filed on May 9, 2022.

(51) Int. Cl. B28C 5/40; C04B 20/10; C04B 28/02

(52) U.S. Cl. CPC B28C 5/406; B28C 5/402; C04B 20/1037; C04B 28/02; C04B 2201/50

(57) ABSTRACT

A method for increasing the force required to separate a solidified deformable material into at least two portions includes adding unmodified fibers and/or modified fibers having high tensile strength, high modulus of elasticity and high shock resistance to the deformable material; the modified fibers having surfaces with integral protuberances and/or attached silica particles emanating from each surface. The modified fibers, when mixed with the deformable material, ultimately form a solidified matrix having increased tensile strength (when compared to the solidified material without having the modified fibers) and increased resistance to separating into two or more portions when a force impacts or strikes a portion of the solidified deformable material.

### BACKGROUND OF THE INVENTION

This Utility Application is based on Provisional Application No. 63/339,789 filed May 9, 2022.

### 1. FIELD OF THE INVENTION

This invention relates to a method for increasing the force required to separate a solidified deformable material into at least two portions; and in particular, to providing a method for increasing the tensile strength, modulus of elasticity and resistance to high impact forces of concrete.

### 2. BACKGROUND OF THE PRIOR ART

Concrete is very strong in compressive strength but relatively weak in tensile strength. Concrete can handle very high static loads but is relatively brittle when presented with impact forces in general and high impact forces in particular. This relatively brittle characteristic limits the usefulness of concrete in certain applications, including but not limited to earthquakes, hurricanes/tornadoes, ballistics and explosions. Additional protection of vital infrastructure or supporting columns could be achieved with the correct reinforcement member in concrete, grout or similar deformable materials that solidify to form a foundation or other support structures requiring increased tensile strength, including but not limited to bridges, buildings, roads, runways, shelters, retaining/sea walls and support columns. Improvements in reinforcement technology provides lighter, dimensionally smaller and more durable structures.

Many types of prior art reinforcement materials, including but not limited to fibers and Rebars, have been developed and studied in the past with the objective being the enhanced tensile strength, ductility, durability and reducing the cost and weight of the cast in place or precast concrete structures. These prior art reinforcement materials have failed to meet the objectives of construction personnel generally because increasing tensile strength and reducing the brittle nature of a solidified deformable material increases the cost and weight of constructing structures. In general, current reinforcement options are restricted by the following: cost prohibitive, weight prohibitive, adds very little to impact strength, vulnerable to corrosion, poor bonding, low modulus of elasticity, incompatible coefficient of expansion, very labor intensive to install, and negatively affects the rheology of the mix of concrete.

A need exists for adding a reinforcement material to a deformable material that ultimately solidifies, whereby the tensile strength of the deformable material increases and the brittle nature of the deformably material decreases, resulting in a solidified deformable material with an increased modulus of elasticity, thereby increasing the force required separate the deformable material into at least two portions.

### SUMMARY OF THE INVENTION

It is an object of the present invention to provide a method for increasing the force required to separate a solidified deformable material into at least two portions. A feature of the method is selecting a deformable material for a predetermined project. Another feature of the present method is determining if the selected deformable material (when solidified) can withstand force specifications calculated for the predetermined project. In the event the selected solidified deformable material cannot withstand force specifications, another feature of the method is to provide multiple samples of the selected deformable material, each sample having the same weight and volume. Still another feature of the method is to provide a unique reinforcement material or fiber for each sample of the selected deformable material, each unique reinforcement material having the same configuration and dimensions. Yet another feature of the method is to uniformly mix a predetermined quantity of a unique reinforcement material with one of the samples of the selected deformable material. Another feature of the method is to configure and dimension each sample of the selected deformable material with a unique reinforcement material uniformly mixed therein, whereupon, each sample of selected deformable material is allowed to solidify for the same preselected time period.

An advantage of the method is that each sample of solidified deformable material with the uniformly mixed predetermined quantity of unique reinforcement material or fiber can be independently tested via an “impact number test” to enable a user of the method to determine the optimum reinforcement material for the selected deformable material for the predetermined project.

Another object of the present invention is to utilize the impact number test to generate an impact number without units for each sample of solidified deformable material with a uniformly mixed unique reinforcement material therein. A feature of the impact number test is to dispose a relatively heavy weight a preselected distance above a horizontal surface of a selected sample of the solidified deformable material. Another feature of the test is to cause the weight to perpendicularly strike the horizontal surface of the selected sample as many times as necessary to separate the selected sample into at least two portions. Still another feature of the test is to count the number of strikes necessary to separate the selected sample into at least two portions (the “impact number”); whereupon, the impact number is listed adjacent to the unique reinforcement material mixed in the solidified deformable material. Another feature of the method is to apply the same impact number test to each sample of solidified deformable material with a unique reinforcement material mixed therein, resulting in a list of impact numbers corresponding to respective unique reinforcement materials (see Table 1, infra).

An advantage of the method is that a user can select the unique reinforcement material having the highest impact number for mixing with the selected deformable material for the predetermined project. Another advantage of the method is that the sample-reinforcement mixture with the highest impact number can be tested to determine if the sample-reinforcement mixture can withstand the force specifications for the predetermined project. Still another advantage of the method is that in the event that the sample-reinforcement mixture with the highest impact number cannot withstand the specified forces for the predetermined project, alternative reinforcement mixtures can be tested to find impact numbers that exceed the previous high impact number; whereupon, the specified forces for the predetermined project are applied to the alternative reinforcement mixture with the highest impact number, and the alternative reinforcement mixture is used or the method is repeated until the required reinforcement mixture is discovered.

Another object of the present invention is to provide an impact number test preferred by the inventor that assigns an impact number without units corresponding to the force required to separate a solidified sample of the selected deformable material into two or more portions for each reinforcement material or fiber selected by the user for possible addition to the selected deformable material. A feature of the method for assigning impact numbers pertaining to each fiber listed for mixing with a selected deformable material is illustrated in Table 1 (see infra), whereby, each listed fiber was independently tested and uniformly mixed in a concrete sample one foot square, one inch thick and horizontally disposed on a solid surface. Each fiber-concrete sample test was conducted whereby a twelve-pound weight was dropped eighteen inches above the horizontal surface of the solidified concrete (the inventor preferred test). The impact number for each independent impact was assigned when the respective solidified concrete-fiber material sample separated into at least two portions. The weight of each tested sample was constant due to the maintained solidified fiber-concrete ratio being maintained for each of the tested samples.

An advantage of the method is that a selected deformable material (preferably concrete) can be represented by a relatively small sample (one foot square and one inch thick, for example) that is impacted by a force (12 pound falling weight, for example) that repeatedly strikes the sample until separating into two or more portions. Another advantage of the method is that the same configured deformable material can be mixed with fibers manufactured from materials including but not limited to nylon, polymers, ceramics, cellulose, natural plants and the fibers listed in Table 1, resulting in the user of the method selecting a preferred solidified mixture based upon the largest number of impacts to separate the solidified mixture. Yet another advantage of the method is that the user can configure multiple samples of the preferred solidified mixture for testing with calculated or speculated maximum impact and/or tensile forces imparted upon the preferred solidified mixture, each solidified mixture having a different fiber. Another advantage of the method is that impact number tests can be developed that determine the optimum deformable material-fiber mixture for withstanding a maximum force by assigning impact numbers to relatively small samples, thereby reducing the size, cost, and testing time for each sample.

Another object of the present invention is to provide a method for modifying selected fibers, whereby the modified fiber results in an impact number greater than the same unmodified fiber (see table 1), when the unmodified and modified fibers are separately mixed with concrete; however, when the deformable material is grout or similar “softer” material, the impact number for an unmodified fiber can be higher than the impact number for a modified fiber. A feature of the method is to modify selected fibers having a relatively smooth surface (polymers for example) via chemical treatment or bonding that includes but not limited to Amino Silane (preferred for polyurethane, epoxy and polyethylene polymers), Epoxy Silane, Methacryl Silane, Alkyl Silane and combinations thereof. The selected Silane corresponds to the selected fiber to be modified (the selection process being well known to those of ordinary skill in the art). Chemically treated fibers result in modified fibers more rigid than fibers without being chemically treated. An advantage of the method is that a selected fiber having a relatively smooth surface is chemically transformed into a modified surface having “hairlike” protuberances across the entire surface that are ultimately “grasped” by a solidified concrete matrix.

An advantage of the method is that the resulting combination of the modified fibers uniformly mixed in deformable concrete increases the tolerance of the resulting solidified concrete matrix to impact forces directed upon the solidified concrete; the same impact forces causing solidified concrete with fibers that are not modified to separate into two or more portions. Another advantage of the method is that the resulting solidified concrete with added modified fibers can withstand higher tensile forces than solidified concrete without added modified fibers. Still another advantage of the method is that any selected modified fiber (including but not limited to the fibers provided in table 1) can be mixed with deformable wet or dry concrete irrespective of ambient conditions.

Another object of the present invention is to provide a method for modifying selected fibers having micro and/or nano dimensioned pores or recesses in the surface of the selected fibers (nylon for example). A feature of the method is to combine selected fibers with a silica rich liquid material for increasing concrete resistance to high impact forces and for increasing the tensile strength of concrete greater than concrete without using the silica rich material. Another feature of the method is to mechanically secure or bond nano or micro dimensioned silica particles in the silica rich material (preferably colloidal silica) in corresponding micro or nano dimensioned pores or recesses in the selected fibers, resulting in strands of modified selected fibers silica particles protruding from the surface of the now modified selected fibers (“mechanical pore impregnation”). Another feature of the method is to select a silica rich material from the group including, but not limited to colloidal silica, sodium silicate, potassium silicate, lithium silicate, magnesium silicate, silane, amino silane, siliconates (organic modified alkali silicates), siloxanes, poly-siloxanes, and combinations thereof.

An advantage of the method is that a selected fiber having pores or recesses with secured silica particles therein is transformed into a modified fiber with a surface having protuberances across the entire surface that are ultimately “grasped” by a solidified concrete matrix. Another advantage of the method is that the cost of procuring colloidal silica is approximately one-tenth the cost of procuring a silane based chemical. Another advantage of the method is that the resulting combination of the modified fibers (with silica particles secured thereto) when uniformly mixed in deformable concrete increases the tolerance of the resulting solidified concrete matrix to impact forces directed upon the solidified concrete; the same impact forces causing solidified concrete without modified fibers to separate into two or more portions. Another advantage of the method is that the resulting solidified concrete with added modified fibers can withstand higher tensile forces than solidified concrete without added modified fibers. Still another advantage of the method is that any selected modified fiber (including but not limited to the fibers provided in table 1) can be mixed with deformable wet or dry concrete irrespective of ambient conditions.

Another object of the present invention (irrespective of chemical treatment or mechanical core impregnation used to modify selected fibers) is to form relatively long, cylindrically configured, modified fiber strands. A feature of the method is to form modified strands having a diameter between 0.001 and 0.125 inches that are ultimately cut to form pellets, each pellet having a length between 0.25 and 4.0 inches. Still another feature of the method is slow mixing (via drill mixing or similar mixing techniques well known to those of ordinary skill in the art) about 25 grams of the selected dry modified fiber pellets for every 3 pounds of dry concrete (cement and aggregate mix) between 3 and 15 minutes depending upon the volume of dry concrete (the larger the volume the longer the mixing); whereupon, about 6 to 7 ounces of water is added to each 25 gram-3 pound combination of dry modified fiber pellets and dry concrete. Alternatively, the dry modified fiber pellets can be added to wet concrete, whereby the 25 gram-3 pound dry concrete ratio is maintained for every 6 to 7 ounces of water added to the dry concrete prior to adding the modified fiber pellets.

An advantage of the present method is the selected fibers can be modified via both the chemical treatment and mechanical core impregnation techniques, thereby increasing the grasp of the solidified concrete matrix upon each pellet (with corresponding increased costs) when compared to only one modification technique being used for the selected fibers. Another advantage of the method is that the resulting combination of concrete and modified fibers pellets (when compared to solidified concrete without the added modified fibers) has increased tensile strength, modulus of elasticity and resistance to relatively high impact forces engaging a solidified concrete-modified fiber pellet structure; resulting in a surface of the concrete-modified fiber pellet structure that may show relatively small fractures after being struck by an object, but with the concrete structure remaining intact with no separated portions.

Still another object of the present invention is to provide a method for preventing a high PH of the water near the modified fibers. A feature of the method is to use the mechanical pore impregnation technique with silica impressed into the pores or recesses in the selected modified fibers described supra. Another feature of the method is to weave or fibrillate two or more relatively long selected fibers (each selected fiber having a substantially cylindrical configuration with a diameter between 0.001 and 0.125 inches) having micro dimensioned apertures or voids for retaining corresponding micro/nano silica particles provided in a silica rich material, thereby achieving mechanical bonding between the selected weaved fibers and the attached silica particles. Another feature of the method is that the relatively long waved modified fibers are cut to form pellets about 4 inches long. Still another feature of the method is that the pellets are disposed in wet concrete, whereby the silica particles attract calcium hydroxide rich water, resulting in the silica reducing the PH of the water near the modified fibers. An advantage of the method is that by preventing a high PH of the water near the modified fibers, the modified fibers are able to retain rigidity, resulting in increased tensile strength, elasticity, and maintained configuration of solidified concrete when a relatively high impact force strikes the surface of the solidified concrete, thereby preventing the solidified concrete from spiting into two or more portions.

Another object of the present invention is to provide a method for oxidizing the surface of a selected fiber to create reactive groups to employ a coupling agent to ultimately modify the selected fiber. A feature of the method for modifying a selected fiber is to employ a direct flame at a temperature that does not exceed 250 degrees Fahrenheit or employ a high intensity UV radiation, whereby either is briefly passed over the fiber. Alternatively, chromic acid may be applied to the fiber for oxidizing the surface of the fiber. Another feature of the method for modifying a selected fiber is that once the surface of the fiber has oxidized, a silane coupling agent including but not limited to amino, epoxy or methacryl based silanes, may be added to the surface of the selected fiber. An advantage of the method is that the once the selected fibers are modified, expansion and contraction rates of the selected fibers are compatible with cementitious materials.

### BRIEF DESCRIPTION OF THE DRAWINGS

Objects, advantages and novel features of the present invention, as well as details of an illustrative embodiment thereof, will be understood from the following detailed description and attached drawings, wherein:

FIG. 1 is a sectional view of a surface portion of a selected unmodified fiber having micro and/or nano dimensioned pores and recesses in the fiber for ultimately receiving particles of a silica material, in accordance with the method of the present invention.

FIG. 1A is a sectional view of a surface portion of a selected modified fiber having protuberances extending from the surface of the fiber.

FIG. 2 is a sectional view of a surface portion of a selected modified fiber having pores in the fiber with particles of silica material secured in the pores.

FIG. 3 is a depiction of selected modified fibers configured and distributed uniformly throughout a concrete block in accordance with the method of the present invention.

FIG. 4 is a depiction of woven or braided modified fibers having micro and/or nano dimensioned pores in the fibers and micro dimensioned voids or apertures formed by the woven modified fibers.

FIGS. 5-6 are depictions of woven or braided modified fibers having no pores but including micro dimensioned voids or apertures formed by woven or braided modified fibers.

FIG. 7 is a depiction of selected modified fibers arranged in a mesh configuration before being added to a deformable material that solidifies in accordance with the method of the present invention.

### DESCRIPTION OF THE PREFERRED EMBODIMENT

Referring now to the drawings, the invention provides a method for increasing the force required to separate a solidified deformable material into at least two portions. The solidified deformable material includes but is not limited to concrete (the preferred construction material for the present invention), grout, plaster and polymers. Further, the method of the present invention increases the tensile strength of deformably material concrete, whereby the concrete resists extraction (“pull out”) forces that would ordinarily remove objects from concrete that does not include the method of the present invention. All fiber, materials and chemicals described herein are well known to those of ordinary skill in the art and are readily ordered from the internet via trademark, tradename, company name and/or generic description.

The method of the present invention includes the preliminary or organizing steps of selecting a deformable material for a predetermined project; researching the force specifications, and/or calculated or speculated maximum impact or tensile forces imparted upon the selected deformable material (after solidifying), and determining if the selected deformable material can withstand the force specifications.

In the event the selected solidified deformable material cannot withstand force specifications, multiple samples of the selected deformable material are prepared with each sample having the same weight and volume. The method includes the step of uniformly mixing a predetermined quantity of an unmodified fiber 10 selected from the group including but not limited to nylon, polymers, ceramics, cellulose, natural plants, and the fibers listed in Table 1 (see infra) with one sample of the selected deformable material.

The method further includes the step of uniformly mixing the same quantity of a modified alternative 12 of the selected unmodified fiber 10 with a second sample of the selected deformable material. Testing both unmodified 10 and modified 12 samples of the same fiber to be mixed with the selected deformable material is required due to the varying test results arising with different deformable materials. For example, mixing an unmodified fiber 10 with a polymer can provide a greater increase in the force necessary to separate the unmodified fiber 10-polymer mix (after solidifying) into two portions, when compared to the force increase required to separate the same solidified modified fiber 12-polymer mix into two portions. Further, mixing a modified fiber 12 with concrete can provide a greater increase in the force necessary to separate the modified fiber 12-concrete mix (after solidifying) into two portions, when compared to the same solidified unmodified fiber 10-concrete mix. The mixed fiber-deformable material formed samples include the same configuration and dimensions, and each formed sample is allowed to solidify for the same preselected time period.

Each mixed fiber-solidified deformable material sample is independently tested via an “impact number test” to enable a user of the method to determine the optimum reinforcement fiber for the selected deformable material for the predetermined project. The impact number test generates an impact number without units for each sample of mixed fiber-solidified deformable material. The impact number test includes disposing a relatively heavy weight a preselected distance above a horizontal surface of a selected sample of the solidified deformable material. The weight ultimately perpendicularly strikes a horizontal surface of the selected sample of mixed fiber-solidified deformable material as many times as necessary to separate the selected sample into at least two portions. The impact number test further includes counting the number of strikes necessary to separate the selected sample into at least two portions (the “impact number”); whereupon, the impact number is listed adjacent to the fiber 10 and 12 mixed in the solidified deformable material. The same impact number test is applied to each selected sample, resulting in a list of impact numbers corresponding to respective unmodified fibers 10 and modified fibers 12 (see Table 1).

The user of the method ultimately selects the fiber 10 and 12 having the highest impact number for mixing with the selected deformable material for the predetermined project. The fiber 10 and 12 with the highest impact number is tested to determine if the fiber when uniformly mixed with the selected deformable material for the predetermined project can withstand the force specifications for the predetermined project. In the event that selected fiber with the highest impact number cannot withstand the specified forces for the predetermined project, alternative modified and unmodified fibers 10 and 12 can be tested with samples of the selected deformable material to find impact numbers that exceed the previous high impact number; whereupon, the specified forces for the predetermined project are applied to the alternative fiber-selected solidified deformable material mixture with the highest impact number, and the alternative reinforcement mixture is used for the predetermined project or the method is repeated until the required reinforcement mixture is discovered.

The inventor preferred impact number test (for concrete) includes dropping a twelve-pound weight from eighteen inches above the horizontal surface (one foot square) of a sample one inch thick of the selected fiber-solidified concrete, and repeating the test and counting the number of strikes until the solidified concrete separates into at least two portions. The impact number (total strikes) for each selected fiber-concrete mixture is assigned when the respective sample separated into at least two portions. The weight of each tested sample was constant due to the solidified fiber-concrete ratio being maintained for each of the tested samples. The user of the method can specify an impact number test that corresponds to their selected deformable material, including but not limited to grout, polymers and plaster, whereby the test parameters (weight impact force and weight distance above the solidified deformable material) are consistent for each impact number test on the same solidified deformable material.

The deformable material samples can receive unmodified fibers 10 and modified fibers 12 manufactured from materials including but not limited to nylon, polymers, ceramics, cellulose, natural plants and the fibers listed in Table 1 that ultimately increase tensile strength, increase modulus of elasticity and increase shock resistance of the deformable material (when solidified) required for the predetermined project, resulting in the user of the method selecting a preferred mixture based upon the largest number of impacts (impact number) to separate the mixture into at least two portions after solidifying. Further, the user can configure multiple samples of the preferred solidified mixture for testing with calculated or speculated maximum impact and/or tensile forces imparted upon the preferred solidified mixture, each solidified mixture having a different fiber 10 or 12. Impact number tests can be developed that determine the optimum deformable material-fiber 10 and 12 mixture for withstanding a maximum force by assigning impact numbers to relatively small samples, thereby reducing the size, cost, and testing time for each sample. Although concrete samples having modified fibers 12 therein are more resistance to impact forces than concrete samples that include unmodified fibers 10, samples of other deformable materials (for example, grout) will have more resistance to impact forces when an unmodified fiber 10 is mix therein.

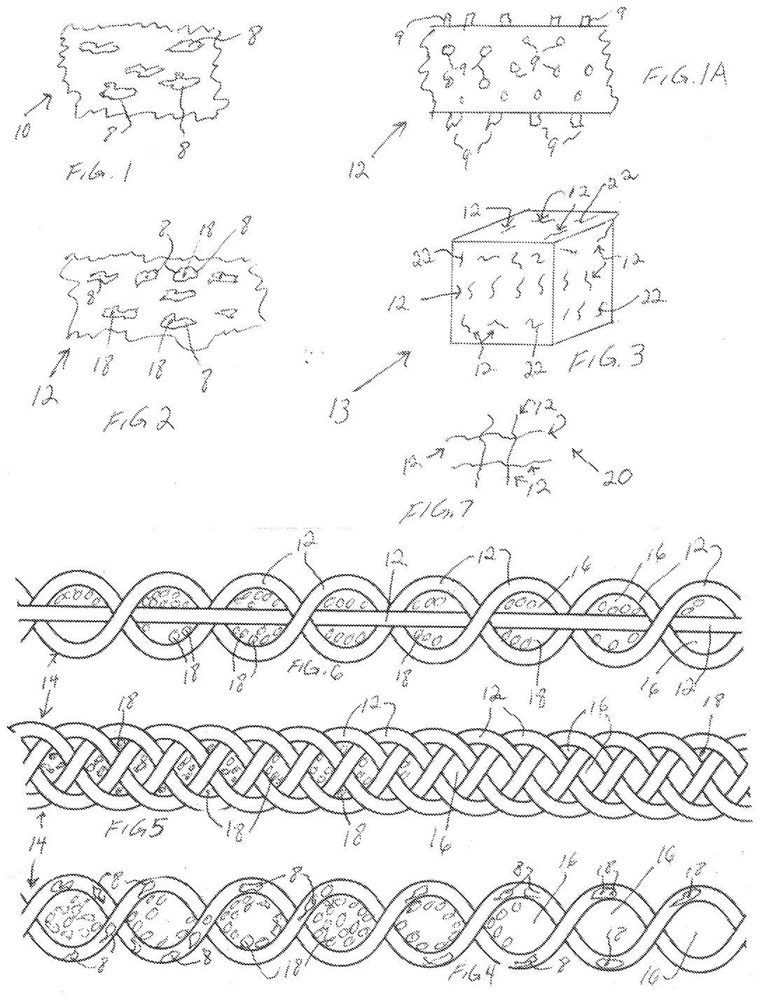

The method includes steps of selecting and adding unmodified 10 or modified strands fibers 12 to a selected deformable material (preferably solidified concrete with a preselected configuration and dimensions) that increases the force required to separate the solidified deformable material into at least two portions when anticipated impact and/or tensile forces are imparted upon the solidified material that would ordinarily result in the solidified material separating into at least two portions. The selected strands of unmodified 10 or modified 12 fibers are cut into pellets 22 (see FIGS. 1A, 2 and 3) before mixing with the substantially liquid deformable material. The pellets 22 are relatively cylindrically configured with diameters substantially between 0.001 and 0.125 inches and with lengths of about four inches. The weight of each tested sample was constant due to the maintained fiber (pellet 22)—concrete ratio being maintained for each of the tested concrete samples.

The step of selecting modified fibers 12 for the predetermined project includes the step of converting unmodified fibers 10 into modified fibers 12 via direct chemical bonding or mechanical pore impregnation methods. The modified fibers 12 are uniformly mixed with and ultimately bonded to deformable wet concrete. Direct chemical bonding is used to modify selected unmodified fibers 10 having a relatively smooth surface, for example, ultra-high molecular weight polyethylene (“UHMWPE”), including Spectra and Dyneema brand fibers 10 (see table 1), are modified via chemical treatment that includes but not limited to Amino Silane (preferred for polyurethane, epoxy and polyethylene polymers), Epoxy Silane, Methacryl Silane, Alkyl Silane and combinations thereof. The selected Silane corresponds to the selected fiber 10 to be modified (the selection process being well known to those of ordinary skill in the art); the chemically treated fiber 10 resulting in modified fibers 12 more rigid than unmodified fibers 10 without being chemically treated. A selected fiber 10 having a relatively smooth surface is chemically transformed into a modified surface 24 having protuberances 9 across the entire surface 24 (see FIG. 1A) that are ultimately “grasped” by a solidified concrete matrix (not depicted).

The modified fibers 12 having protuberances 9 include a substantially cylindrical configuration with a preferred diameter between 0.001 and 0.125 inches, and a length that forms relatively long strands that are used independent from other modified fibers 12. Alternatively, multiple selected modified fibers 12 can be intertwined to form braided strands (see FIGS. 4-6). The diameter of each modified fiber 12 with the protuberances 9 remains substantially between 0.001 and 0.125 inches. Irrespective of the modified fibers 12 being single long strands or braided strands 14, the modified fibers 12 are cut to form pellets 22, each pellet 22 includes a preferred length between 0.25 and 4.0 inches. The pellets 22 are ultimately slow mixed with deformable (dry) concrete (via drill mixing or similar mixing techniques well known to those of ordinary skill in the art), whereby about 25 grams of selected dry modified fiber pellets 22 are mixed with 3 pounds of dry concrete (cement and aggregate mix) between 3 and 15 minutes depending upon the volume of dry concrete (the larger the volume the longer the mixing); whereupon, about 6 to 7 ounces of water is added to each 25 gram-3 pound combination of the dry modified fiber pellets 22 and dry concrete. Alternatively, the dry modified fiber pellets can be added to wet concrete, whereby the 25 gram of pellets 22 for every 3 pounds of dry concrete ratio is maintained for every 6 to 7 ounces of water added to the dry concrete prior to adding the modified fiber pellets 22.

The combination of the modified fibers 12 uniformly mixed in deformable concrete increases the tolerance of the resulting solidified concrete matrix to impact forces directed upon the solidified concrete 13; the same impact forces causing solidified concrete without modified fibers to separate into two or more portions. Further, the resulting solidified concrete with added modified fibers can withstand higher tensile forces than solidified concrete without added modified fibers. Any selected modified fiber 12 (including but not limited to the modified fibers 12 provided in table 1) can be mixed with deformable wet or dry concrete irrespective of ambient conditions.

Selected unmodified fibers 10 having micro and/or nano dimensioned pores or recesses 8 (see FIG. 1) in the surface of the selected fibers (nylon for example), are modified via a silica rich material (preferably colloidal silica) that includes a liquid having micro and/or nano dimensioned silica particles 18 that are forcibly inserted into cooperating micro or nano dimensioned pores 8 in the selected fibers 10, resulting in modified fibers 12 (“mechanical pore impregnation treatment”) having projections extending from the surface of the selected fibers. When fibers 10 are selected having a relatively smooth surface without the pores 8, relatively long fibers 10 are woven into braided forms 14 with apertures or voids 16 (see FIGS. 4-6 depicted as modified fibers 12 forming braids 14) via steps described infra.

When using the mechanical pore impregnation treatment, irrespective of the unmodified fiber 10 selected for the present method, each fiber 10 will include pores 8 (FIG. 1), or if the surface of the fiber 10 is without pores; multiple selected unmodified fibers 10 will be formed into braids 14 having voids or apertures 16 (FIGS. 4-6). Each unmodified fiber 10 includes a substantially cylindrical configuration with a preferred diameter between and 0.125 inches with a preselected length that cooperates with adjacent unmodified fibers 10 having substantially the same length to form relatively long braids 14 of the selected material that is ultimately modified by mechanical pore impregnation treatment, resulting in modified braids 14 that are cut to form pellets 22. Each pellet 22 includes a preferred length between 0.25 and 4.0 inches. The dry modified fiber pellets 22 are ultimately added to wet concrete, whereby 25 grams of pellets 22 for every 3 pounds of dry concrete is maintained for every 6 to 7 ounces of water added to dry concrete prior to adding the modified fiber pellets 22. When the pellets 22 are added to deformable or relatively “liquid” concrete, the resulting solidified concrete block 13 has increased tensile strength and increased resistance to relatively high impact forces.

Irrespective of direct chemical bonding treatment or the mechanical pore impregnation treatment being used to form selected modified fibers 12, the more viscous the wet concrete, the shorter the modified fibers 12. Modified fibers 12 having lengths longer than 4.0 inches have a greater chance of wrapping around each other or individually forming a ball (“balling”) instead of a substantially lineal configuration. Further, a modified fiber 12 having a smaller diameter will provide more fiber 12 by weight for the deformable material, thereby delaying cracks from forming upon the surface of solidified concrete, but the overall tensile strength of the solidified concrete is reduced.

The selected modified strands of fibers 12 are ultimately added to a deformable material that includes but not limited to concrete, grout, plaster and polymers-preferably polyethylene. Referring to the unmodified fiber strands 10 having micro and/or nano dimensioned pores 8 or voids 16 when multiple strands 10 are braided, the fiber strands 10 must be relatively rigid and include pores or gaps 8 in the micrometer to nanometer range and/or apertures 16 in the micrometer range that ultimately receive and retain silica particles via static charge, pressure or similar bonding properties that ties silica particles 18 together, whereby the particles substantially fill each gap 8 and aperture 16.

The strands of modified fibers 12 in Table 1 are hydrophobic or nearly hydrophobic to repel water. When adding the strands of modified fibers 12 to concrete, the PH of the water adjacent to the modified fibers 12 is reduced from a 10 to 12 range to about 9 throughout the curing process, thereby increasing the bonding of the strands of modified fibers 12 to a porous cementitious matrix, resulting in concrete having increased tolerance to impact forces and increased tensile strength.

The modified fibers 12 after being cut into pellets 22, are randomly added via pre-blending the modified fibers 12 with dry concrete into a dry mix via conventional mixing methods, including but not limited to a drill mixer, mortar mixer or ribbon blender each well known to those of ordinary skill in the art. Alternatively, the modified fibers 12 may be added to wet concrete (or similar deformable material such as grout and polyethylene that ultimately solidifies), or the modified fibers 12 may be added at the same time water is being added to the concrete during mixing. The modified fibers 12 should be added slowly via a mixing device to reduce any clumping or agglomeration of the concrete, thereby forming a porous concrete matrix having modified fibers 12 integrally joined to the deformable “wet” concrete that ultimately solidifies into a block 13 or other selected configuration that requires increased resistance to relatively high impact and pull out (extraction) forces.

Generally, the more viscous the wet concrete, the shorter the modified fibers 12, resulting in modified fiber pellets 22 having lengths 0.25 to 4.0 inches. Modified fibers 12 or pellets 22 longer than 4.0 inches have a greater chance of wrapping around each other or individually forming a ball (“balling”) instead of a substantially lineal configuration. Further, a modified fiber 12 having a smaller diameter than 0.001 inches will provide more fiber 12 by weight for the deformable material, thereby delaying cracks from forming upon the surface of solidified concrete, but the overall tensile strength of the solidified concrete 13 is reduced.

The selected direct chemical bonding treatment can be sprayed at low pressures (typically 35 psi) upon the selected strands of fiber 10 before or after the selected strand of fiber 10 is “chopped” to form pellets between 0.25 and 4.0 inches in length with diameters between 0.001 and 0.125 inches. Instead of a being sprayed, the selected fiber may be drawn (before being chopped) through a sealed container with one of the above chemical treatment liquids predisposed inside the container. Another chemical treatment for the selected strand of fiber 10 is to submerge the fiber 10 in a selected chemical (described supra) using a submersion technique described infra.

The strands of modified fibers 12 in Table 1 are hydrophobic or nearly hydrophobic to repel water included in the mix with cement and aggregate having a typical or standard quantity of water corresponding to a predetermined concrete project (well known to those of ordinary skill in the art). When adding the strands of modified fibers 12 to concrete, the PH of the water adjacent to the modified fibers 12 is reduced from a 10 to 12 range to about 9 throughout the curing phase of the concrete, thereby increasing the bonding of the strands of modified fibers 12 to a porous cementitious matrix, resulting in concrete having increased tolerance to impact forces and increased tensile strength.

Multiple stands of modified fibers 12 can be woven (before being chopped) or fibrillated into a braid 14 or similar configuration (see FIGS. 5-6) that includes nano (FIG. 5) or micro (FIG. 6) meter dimensioned voids or apertures 16 for retaining a corresponding micro or nano silica particles 18 in a silica liquid material when included in the direct chemical bonding treatment described supra. The silica material 18 is added to the chemical treatment (described supra) to achieve sufficient water repulsion by the modified fibers 12 by lowering the PH of water to about 9 throughout the curing phase of the concrete. The silica material is selected from a group that includes but not limited potassium silicate, sodium silicate, meta silicate, lithium silicate, magnesium silicate, colloidal silica, silanes, siloxanes, vinyl silanes, alkoxy, polysiloxanes and combinations thereof. The silica material 18 ultimately impregnates or otherwise achieves mechanical bonding with strands of modified fibers 12 via the gaps or pores 8, or achieves mechanical bonding with braided strands 14 of modified fibers 12 via voids or apertures described infra. Generally, both direct chemical bonding treatment and mechanical pore impregnation treatment methods are not used for the same modified fibers 12 due to the cost for direct chemical bonding being as much as ten times greater than the cost for the mechanical pore impregnation treatment.

When particles 18 of the silica materials are mechanically bonded with the selected strands of modified fibers 12 (before or after being cut), the expansion and contraction of the modified fibers 12 are reduced. This reduction results in the silica materials being more compatible with deformable concrete than with other types of deformable materials including but not limited to grout, plater and polymers. For example, the coefficient of linear expansion of polyethylene is 0.000111, whereas concrete has a linear expansion of 0.000005. The greater linear expansion of polyethylene can generate internal forces that ultimately damage the modified fibers 12.

For example, after selecting nylon fibers 10 (the preferred fiber) from Table 1, then selecting the chemical treatment or bonding (described supra) to form a modified fiber 12, and selecting one of the silica materials to be added to the chemical treatment and ultimately providing silica particles 18 secured to the modified fibers 12, the modified fibers 12 are disposed and mixed in wet concrete; whereupon, the selected micro/nano silica particles 18 of the silica material retained in cooperating micro or nano dimensioned pores 8 and voids or apertures 16 in the nylon modified fibers 12, attract calcium hydroxide rich water. The selected micro/nano meter dimensioned silica particles 18 react with micro and nano meter dimensioned calcium hydroxide particles entering the micro and nano dimensioned pores 8 and voids 16 to form micro/nano dimensioned calcium silicate hydrate (see equation below) together with other hard crystal formations that reduce the PH of the water near the modified fibers 12. The PH of the calcium hydroxide can be as high as “10,” when concrete is in a deformable state, and as high as “12” before the concrete cures out.

3CaO(calcium oxide)+SiO₂(silicate)+H₂O→CaO+SiO₂+H₂O calcium silicate hydrate and 2Ca(OH)₂(calcium hydroxide)

The PH of the water in close proximately to the modified fibers 12 is reduced after the calcium hydroxide has reacted with the particles 18 of the silica material, resulting in the micro/nano calcium silicate hydrate forming a network in and around the modified fibers 12 that increases the bonding strength of the modified fibers 12 to a porous cementitious matrix when compared to modified fibers 12 without the silica particles 18. The increased bonding of the modified fibers 12 to the porous cementitious matrix results in a solidified concrete having an increased “grasp” upon an object secured in the concrete, thereby reducing the chance of the object being extracted from the solidified concrete; and that maintains the elasticity and structural integrity of the solidified concrete when receiving relatively high impact forces generated from foreign objects striking the concrete.

Non-modified fibers 10 included in solidified concrete fail to provide the same results as modified fibers 12 integrated into the concrete matrix, when comparing tensile strength, elasticity and resistance to separation when receiving impacts from objects striking the surface of a solidified concrete (see Table 1). The particles 18 in a selected silica material are ultimately retained in respective pores 8 of a single modified fiber 12 and the voids 16 of woven strands of modified fibers 12. The particles 18 in the selected silica material are retained via submersion techniques (well known to those of ordinary skill in the art) employed to combine the selected treatment chemical (see supra) and the selected modified fiber 12.

The submersion technique without including silica materials includes rolls or coils formed from a selected fiber 10 having a cylindrical configuration with a diameter between 0.001 and 0.125 inches disposed in the selected treatment liquid in a container at ambient temperature and pressure for 24 hours; whereupon, the rolls of selected fiber 10 are removed for drying via heat at substantially 250 degrees Fahrenheit provided by vacuum or forced air, resulting in rolls of modified fibers 12.

When including silica materials having particles 18, the submersion technique provides submerging one or more fiber rolls or coils having diameters two inches or greater from the selected fiber 10 in a chosen silica rich liquid. If a silicate material is not required, a colloidal silica is preferred. The colloidal silica material includes an amorphous colloidal silica particle 18 size ranging from 5 nanometers to 30 nanometers. The colloidal silica particles 18 size range create a superior interlocking effect and a greater density for the resulting modified fibers 12 when combined with a concrete matrix. At least half of the colloidal silica particles 18 range in size from 5 nanometers to 10 nanometers. The particles 18 of a silicate material range in size from 10 nanometers to 50 nanometers, resulting in less interlocking between the silicate material 18 and the solidified concrete matrix, but the silicate material is generally less expensive than an equal quantity of colloidal silica.

After the selected fiber 10 is submerged for 24 hours in the selected silica rich liquid, the container is placed in a vacuum chamber and full vacuum (20 inches Hg) is pulled for 90 minutes to remove all air that is disposed on the selected fiber 10 and in voids between fiber 10 portions, resulting in silica rich liquid penetrating most portions of the selected fiber 10. The container and the contents therein are exposed to a positive pressure of at least 30 psi for a minimum of 15 minutes, thereby urging particles 18 of the selected silica material deep into the pores 8 in the fibers 10 and/or the voids 16 in the braided fibers 10; whereupon, the now modified fibers 12 are removed from the silica solution to dry in a low humidity (30% or less) room at 70 to 100 degrees Fahrenheit. Particles 18 of the selected silica material are secured in voids or apertures 16 in dried modified fibers 12 in a braided form 14, include intermittent spaces between adjacent particles 18 that ultimately receive deformable concrete, thereby increasing interlocking between the modified fibers 12 and deformable concrete and increasing the density between the modified fibers 12 and the deformable concrete when mixed together, resulting in a solidified concrete matrix having increased tensile strength and increased resistance to separating into two or more portions when the concrete is struck by a foreign object.

A selected fiber from Table 1 that is not porous, but can be modified to have some reactivity with deformable concrete, is ultra-high molecular weight polyethylene (“UHMWPE”) 10. The UHMWPE fibers 10 include Spectra and Dyneema brand fibers. When selecting the UHMWPE fiber 10 for use to increase the resistance of solidified concrete to relatively high impact forces, the surface of the UHMWPE fiber must first be oxidized to create reactive groups to employ a coupling agent. The oxidizing of UHMWPE fiber can be achieved by several methods including but not limited the preferred methods of using a controlled direct flame of no more than 250 degrees Fahrenheit briefly passed over the UHMWPE fiber 10 using a high intensity UV radiation, or using an application of chromic acid. Once the surface of the fiber has oxidized, groups of a silane coupling agent may be applied. The preferred coupling agents include amino, epoxy, and methacryl based silanes.

When selecting a fiber from Table 1 (or a fiber not included in Table 1) for modification for increasing concrete's tolerance to forces impacting the surface of the concrete, the selected fiber once modified or treated has to include expansion and contraction rates compatible with the cementitious materials to which the modified fiber is being added. For example, some Aramid fibers expand and contract differently than an expansion type concrete, resulting in the cracking of the concrete because of the increased internal stresses generated by the Aramid fibers within the concrete. Alternatively, UHMWPE fiber has a coefficient of expansion higher than concrete, resulting in the UHMWPE fiber being used in concrete, but not preferred.

The Para aramid and UHMWPE fibers 10, when modified, can be used in a high alkaline environment because of the reduction of alkalinity in the immediate vicinity of the modified fibers 12, thereby enabling the modified fibers 12 to bond to concrete. When the modified fibers 12 are exposed to long term high alkaline environments, pozzolans such as metakaolin are used in the cement to reduce alkalinity of the cement mix.

The modified fibers 12 do not increase the weight of the cement mix, but instead the weight of the cement mix is reduced, whereby, for example, Aramid is 5.6 times lighter than steel and UHMWPE is 8 times lighter than steel.

The modified fibers 12 disperse relatively easy in the concrete or grout mix when reinforcing the mix. Untreated (unmodified) fibers 10 are prone to static cling, curling and “balling,” making the fibers 10 difficult to blend into the mix. Treating the fibers with silicas and/or silanes (modified fibers 12) reduces the surface (“static”) charge upon the fibers 12 and “stiffens” the fibers, thereby enabling the fibers to quickly and evenly spread throughout a grout or concrete mix.

The modified or treated fibers 12 can be added and mixed into dry bag products of grout or cement. Untreated fibers will ball up when mixed with dry cementitious components, resulting in untreated fibers not being added into dry bag products of grout or cement.

The shape or configuration of single strands (substantially lineal) of the modified fibers 12 can enhance mechanical bonding with a deformable material that ultimately solidifies, thereby resisting a structure from being “pulled out” from a solidified concrete or grout material when modified fibers 12 are added. The configuration of the modified fibers 12 can include but not limited to twisted or braided strands (see FIGS. 5-6). Polymer monolithic fiber 10 will have little or no porosity, which reduces the quantity of treatment chemical and or silica material particles attaching to the monolithic fiber 10, thereby rendering a monolithic modified fiber 12 inferior in performance relative to the modified fibers 12 having a braided configuration as illustrated in FIGS. 5-6.

Referring to FIG. 7, a preferred configuration for the modified fibers 12 includes a mesh or substantially a “hash sign (#)” configuration 20 formed from modified fibers 12 having diameters between 0.001 and 0.125 inches, and having lengths between 0.25 and 4.0 inches to prevent the modified fibers 12 from wrapping and balling. The mesh configuration enables the modified fibers 12 to disperse into wet or dry mixes of a deformable material and combine with the matrix of the deformable material, whereby the mesh configuration gives the solidified deformable material added mechanical grasping capability upon a structure that is inserted into the deformable material. The mesh configuration 20 can be chemically treated in the same manner as a single strand of modified fiber 12 as described supra.

The following impact tests (the number of impacts or “blows”) were separately conducted on the listed non-modified fibers 10 and modified fibers 12, each fiber independently tested and uniformly mixed in a concrete portion one foot square, one inch thick and horizontally disposed on a solid surface. Each fiber-concrete test was conducted whereby a twelve-pound weight was dropped eighteen inches above the horizontal surface of the solidified concrete. The break point for each independent impact test occurred when the respective solidified concrete-fiber material sample separated into at least two portions. The weight of each tested sample was constant due to the maintained fiber (pellet 22)—concrete ratio (see supra) being maintained for each of the tested samples.

TABLE 1
BLOWS to BREAK TESTED UNMODIFIED (10)
and MODIFIED FIBERS (12) in CONCRETE

| | |
|---|---|
| Test 1: control test with no fibers | 1 |
| Test 2: AR Fiberglass not modified (10) | 7 |
| Test 3: Carbon Fiber not modified (10) | 22 |
| Test 4: Poly Vinyl Alcohol (“PVA”) not modified (10) | 31 |
| Test 5: UHMWPE not modified (10) | 74 |
| Test 6: UHMWPE modified (12) | 400 |
| Test 7: Para Aramid not modified (Kevlar ®) (10) | 133 |
| Test 8: Para Aramid modified (Kevlar ®) (12) | 826 |
| Test 9: Nylon not modified (10) | 87 |
| Test 10: Nylon modified (12) | 1119 |

The high impact force testing for each test revealed that the flexural strength of the selected concrete-modified fiber 12 combination was increased by about 300% when compared to a concrete-non modified fiber 10, and the compressive strength of the concrete-modified fiber 12 combination remained the same as the compressive strength of the concrete-non modified fiber 10. Further, the flexural strength of UHMWPE was increased 280% and the flexural strength for Kevlar was increased 318%.

In operation, the user includes the following steps for a method for increasing the force required to separate a solidified deformable material into at least two portions:

Selecting a deformable material for a predetermined project. Although concrete is the focus for the present method, other deformable materials may include but not limited to grout, polymers or plaster, which are not exposed to relatively high impact or tensile forces. A deformable material not exposed to relatively high impact or tensile forces would require fibers 10 from table 1 with a lower number of impacts causing separation into at least two portions.

Selecting material for manufacturing strands of fibers for mixing in the deformable material. The fibers selected from the group including but not limited to nylon, polymers, ceramics, cellulose, natural plants and the fibers listed in Table 1. Each selected fiber will be uniformly mixed in a sample of portion of the deformable material; whereupon, the combined fiber and sample portion will ultimately solidify and receive an impact number test.

Selecting a treatment chemical for strands of fibers 10 having a relatively smooth surface from a group that includes but not limited to Amino Silane, Epoxy Silane, Methacryl Silane, Alkyl Silane and combinations thereof. The selected treatment chemical transforms the relatively smooth surface of the strands of fibers 10 into a surface having protuberances distributed across the entire surface of the strands of fibers 10, thereby providing a modified fiber 12 with a “rough” surface for the deformable material to grasp upon.

Selecting a silica material for strands of fibers 10 having a surface with pores 8 and gaps in the surface from a group that includes but not limited to potassium silicate, sodium silicate, meta silicate, lithium silicate, magnesium silicate, colloidal silica, silanes, siloxanes, vinyl silanes, alkoxy, polysiloxanes and combinations thereof. The silica material including micro/nano dimensioned silica particles 18 that are ultimately retained (via static charge) in cooperating micro/nano dimensioned pores 8 in the strands of selected fibers 10 or in the voids or apertures 16 of fibers 10 woven into braided forms 14 (FIGS. 5-6), thereby providing modified fibers 12 with a rough surface for the deformable material to grasp upon.

Configuring and dimensioning the unmodified fibers 10 and modified fibers 12 for the selected deformable material. All unmodified fiber strands 10 and modified fibers strands 12 are “chopped” whereby pellets are configured having lengths between 0.25 and 4.0 inches and diameters between 0.001 and 0.125 inches. Alternatively, multiple selected strands of modified fibers 12 may be woven to form configurations depicted in FIGS. 5-6. The woven strands 12 are “chopped” to configure pellets between 0.25 and 4.0 inches in length with each strand of modified fiber 12 having a diameter between 0.001 and 0.125 inches.

Determining the maximum number of impacts (impact number test) required to separate solidified samples of a selected fiber-deformable material combination into at least two portions. The listed number of impacts (impact number, see Table 1) for each fiber 10 and 12 mixed with a concrete sample provides a maximum impact number (1119) for a modified Nylon fiber 12 (see Table 1) that, when mixed in deformable concrete and allowed to solidify, provides the greatest increased force requirement for separating the solidified Nylon fiber 12 concrete combination into at least two portions, thereby providing the optimum fiber from the Table 1 list of selected unmodified and modified fibers 10 and 12 for mixing with concrete. The list of Table 1 shows the control test for concrete with no fibers has an impact number of 1, meaning that 1 impact between the test weight and the concrete control test caused the sample of concrete to separate into two portions, thereby providing a basis for selecting any fiber listed in Table 1 for increasing the force required to separate the concrete used for the predetermined project into at least two portions.

The selected unmodified fiber 10 or modified fiber 12 is uniformly mixed with the selected deformable material; whereupon, the mixed fibers and deformable material are allowed to solidify, whereby the mixture has increased the strength of the solidified deformable material and increased the force required to separate the solidified deformable material into at least two portions, when compared to the solidified material without adding unmodified fibers 10 or modified fibers 12.

If the fiber 10 selected from table 1 (or outside of table 1) has an undulating (not smooth) surface with relatively few pores and gaps 8, a combination of both chemical treatment and silica material (particle 18 attachment) from the aforementioned groups can be used to form protrusions extending from the undulating surface and to form a micro/nano calcium silicate hydrate network in and around the modified fibers 12. The combination of chemical treatment and particles in the silica material increase the bonding strength of the modified fibers 12 and a porous cementitious matrix when compared to modified fibers 12 without the combined chemical and silica material particles 18 attachment. The bonding of the modified fibers 12 to the porous cementitious matrix results in a solidified concrete that “grasps” and prevents an object secured in the concrete from being extracted from the concrete; and that maintains the elasticity and structural integrity of the solidified concrete.

The foregoing description is for purpose of illustration only and is not intended to limit the scope of protection accorded this invention. The scope of protection is to be measured by the following claims, which should be interpreted as broadly as the inventive contribution permits.

1. A method for increasing the force required to separate a solidified deformable material into at least two portions, said method comprising the steps of:
selecting a deformable material for a predetermined project;
selecting multiple materials for manufacturing multiple strands of fibers for the predetermined project;
determining if said manufactured strands of fibers include a relatively smooth surface without protuberances;
determining if said manufactured strands of fibers include a surface having pores and/or gaps;
selecting a treatment chemical for said manufactured strands of fibers having a relatively smooth surface from a group that includes Amino Silane, Epoxy Silane, Methacryl Silane, Alkyl Silane and combinations thereof;
selecting a silica material for said manufactured strands of fibers having a surface with pores and gaps in the surface;
modifying said manufactured strands of fibers having a relatively smooth surface via said selected treatment chemical, resulting in strands of fibers having a surface with protuberances;
modifying said manufactured strands of fibers having a surface with pores and/or gaps via inserting said selected silica material into said pores and/or gaps, resulting in strands of fibers having projections extending from the surface of said of said strands of fibers;
configuring and dimensioning said manufactured strands of fibers for said selected deformable material, thereby forming multiple fiber pellets from each manufactured fiber strand;
configuring and dimensioning said modified manufactured strands of fibers, thereby forming multiple modified fiber pellets from each modified manufactured fiber strand;
mixing a predetermined quantity of fiber pellets from one selected fiber strand in a sample of said deformable material, whereby fiber pellets from each selected fiber strand are ultimately mixed with a dedicated sample of said deformable material;
allowing all fiber pellets-deformable material mixture samples to solidify;
determining the number of impacts required to separate each sample of solidified fiber pellets-deformable material mixture into at least two portions;
selecting the solidified fiber pellets-deformable material sample having the greatest number of impacts required to separate the respective sample into at least two portions; and
mixing fiber pellets of the sample having the greatest number of impacts with said selected deformable material for the predetermined project; whereupon, said mixed fiber pellets of the sample having the greatest number of impacts and said selected deformable material for the predetermined project is allowed to solidify, whereby said mixture has increased the force required to separate said solidified deformable material into at least two portions.

2. The method of claim 1 wherein the step of selecting deformable material for a redetermined project includes the step selecting a deformable material from the group including concrete, grout, polymers, plaster and combinations thereof.

3. The method of claim 1 wherein the step of selecting material for manufacturing strands of fibers include the step of selecting a material from the group including AR fiberglass, carbon fiber, poly vinyl alcohol, UHMWPE, Kevlar, nylon and combinations thereof.

4. The method of claim 1 wherein the step of selecting a treatment chemical includes the step of selecting a chemical from the group including Amino Silane, Epoxy Silane, Methacryl Silane, Alkyl Silane and combinations thereof, thereby forming strands of modified fibers.

5. The method of claim 1 wherein the step of selecting a treatment chemical includes the step of spraying said selected treatment chemical at substantially 35 psi upon said selected strands of fiber before and/or after said selected strands of fiber are configured.

6. The method of claim 1 wherein the step of selecting a silica material for manufactured strands of fibers having a surface with pores and gaps in the surface includes the step of selecting a silica material containing micro/nano dimensioned particles from the group including potassium silicate, sodium silicate, meta silicate, lithium silicate, magnesium silicate, colloidal silica, silanes, siloxanes, vinyl silanes, alkoxy, polysiloxanes and combinations thereof.

7. The method of claim 6 wherein the step of selecting a silica material for manufactured strands of fibers having a surface with pores and gaps in the surface includes the step of securing micrometer/nanometer dimensioned silica particles in said selected silica material into micrometer/nanometer dimensioned voids and pores in said manufactured strands of fibers, thereby achieving mechanical bonding between said manufactured strands of fibers and silica particles, resulting in modified strands of fibers.

8. The method of claim 7 wherein the step of securing micrometer/nanometer dimensioned silica particles in said micrometer/nanometer dimensioned voids and pores in said manufactured strands of fibers, includes the step of submerging said manufactured strands of fibers in a silica rich liquid.

9. The method of claim 8 wherein said silica rich liquid includes a colloidal silica having an amorphous colloidal silica particle size ranging from 5 nanometers to 30 nanometers, resulting in a greater density for said modified fibers when combined with said deformable material.

10. The method of claim 9 wherein said silica rich liquid includes particles of a silicate material ranging in size from 10 nanometers to 50 nanometers.

11. The method of claim 8 wherein the step of submerging said modified fibers in said silica rich liquid includes the step of submerging said modified fibers in said silica rich liquid for 24 hours; whereupon, said modified fibers are removed from said silica rich liquid and disposed in a vacuum chamber having a vacuum of 20 inches of Hg for 90 minutes for removing all air disposed on said modified fibers, resulting in said silica rich fluid penetrating said voids and pores in said modified fibers.

12. The method of claim 11 wherein the step of disposing said modified fibers in a vacuum chamber includes the step of replacing said vacuum of 20 inches of Hg with a positive pressure of at least 30 psi for a minimum of 15 minutes, thereby urging silica materials into said voids and pores of said modified fibers; whereupon, said modified fibers are removed from said vacuum chamber and disposed in a room having a maximum of 30% humidity at 70 to 100 degrees Fahrenheit.

13. The method of claim 1 wherein the step of configuring and dimensioning said fibers include the step of chopping said fibers, thereby forming pellets having lengths between 0.25 and 4.0 inches and diameters between 0.001 and 0.125 inches.

14. The method of claim 1 wherein the step of configuring and dimensioning said fibers include the step of combining multiple selected strands of fibers, whereby said selected strands of fibers are woven to form configurations; whereupon, said multiple selected strands of fibers are chopped to configure pellets between 0.25 and 4.0 inches in length with each strand of fiber of each pellet having a diameter between 0.001 and 0.125 inches.

15. A method for increasing the tensile strength and resistance of solidified deformable material to forcible separation into two or more portions, said method comprising the steps of:
selecting deformable material for a predetermined project;
selecting material for manufacturing strands of fibers for the predetermined project;
selecting a treatment chemical for said manufactured strands of fibers, said treatment chemical for said manufactured strands of fibers including but not limited to Amino Silane, Epoxy Silane, Methacryl Silane, Alkyl Silane and combinations thereof, said treatment chemical ultimately forming modified fibers;
configuring and dimensioning said modified fibers for said selected deformable material;
selecting an optimum chemically treated, configured and dimensioned modified fiber for mixing with said selected deformable material via an impact number test;
mixing said selected optimum modified fiber and said selected deformable material; and
allowing said deformable material to solidify after said selected optimum modified fiber has been disbursed substantially proportionately throughout said selected deformable material; whereby, said selected optimum modified fiber mixed with said selected solidified deformable material has increased the force required to separate said selected solidified deformable material into at least two portions.

16. The method of claim 15 wherein said step of selecting a treatment chemical for said manufactured strands of fibers include the step of selecting a silica material that ultimately engages said manufactured strands of fibers.

17. The method of claim 16 wherein said step of selecting silica material includes the step of securing micrometer/nanometer dimensioned silica material in micrometer/nanometer dimensioned voids and pores in said manufactured strands of fibers, thereby achieving mechanical bonding between said modified fibers and particles in said silica material.

18. A method for increasing the force required to separate solidified concrete into at least two portions, said method comprising the steps of:
selecting deformable concrete for a predetermined project;
selecting material for manufacturing strands of fibers for the predetermined project;
selecting silica material that is ultimately secured to said manufactured strands of fibers;
securing micrometer/nanometer dimensioned silica material particles in cooperating micrometer/nanometer dimensioned pores in said strands of fibers, thereby forming modified fibers;
selecting optimum configured and dimensioned modified fibers for mixing with said selected deformable concrete via an impact number test;
mixing said optimum configured and dimensioned modified fibers with said deformable concrete; and
allowing said deformable concrete to solidify after said modified fibers have been disbursed substantially proportionately throughout the deformable concrete; whereby, said solidified concrete combined with said modified fibers has increased the force required to separate said solidified concrete into at least two portions when relatively high impact forces and/or tensile forces engage said solidified concrete.

19. The method of claim 18 wherein the step of selecting silica material includes the step of selecting silica material from the group including potassium silicate, sodium silicate, meta silicate, lithium silicate, magnesium silicate, colloidal silica, silanes, siloxanes, vinyl silanes, alkoxy, polysiloxanes and combinations thereof.

20. The method of claim 18 wherein the step of forming modified fibers includes the step of configuring and dimensioning said modified fibers, whereby said modified fibers are formed into pellets having lengths between 0.25 and 4.0 inches and diameters between 0.001 and 0.125 inches.
